(19) United States
(12) Patent Application Publication
(10) Pub. No.: US 2013/0076899 A1
(43) Pub. Date: Mar. 28, 2013

(54) METHOD AND DEVICE FOR DETECTING AN INCORRECT REPRESENTATION OF IMAGE DATA ON A DISPLAY UNIT

(71) Applicants: Uwe Eckelmann-Wendt, Wolfenbuettel (DE); Bernhard Evers, Braunschweig (DE); Ralf Pinger, Braunschweig (DE)

(72) Inventors: Uwe Eckelmann-Wendt, Wolfenbuettel (DE); Bernhard Evers, Braunschweig (DE); Ralf Pinger, Braunschweig (DE)

(73) Assignee: SIEMENS AKTIENGESELLSCHAFT, MUENCHEN (DE)

(21) Appl. No.: 13/702,351

(22) PCT Filed: Jun. 6, 2011
(86) PCT No.: PCT/EP11/59260

§ 371 Date: Dec. 6, 2012

(30) Foreign Application Priority Data
Jun. 11, 2010 (DE) 10 2010 023 891.0

(51) Int. Cl. H04N 17/00

(52) U.S. Cl. CPC H04N 17/00
USPC 348/143

(57) ABSTRACT

An incorrect representation of image data on a display unit is detected with the novel method. In order to enable prompt and particularly reliable detection of an incorrect representation of image data on the display unit, the image data to be displayed are transmitted to the display unit, test data are acquired by electronically detecting at least part of the image represented on the display unit, and an incorrect representation of the image data on the display unit is determined by electronically evaluating at least part of the detected test data. A device for detecting an incorrect representation of image data on a display unit makes use of the novel method.

An incorrect representation of image data on a display unit, i.e. on a screen, monitor or other display, can have serious consequences, depending on the purpose of the display unit. This is particularly true in cases in which display units are applied in circumstances that are relevant or even critical to safety. Examples of this might include applications in fields such as railway, aeronautical, automobile, military, medical or power engineering, such as for instance in nuclear power stations.

Generally speaking, hardware can fail as a result, for instance, of ageing, wear or of external influences. Presentday secure systems generally operate with computer support, in which the status of the system concerned is represented on a display unit. Because the operating activity of the personnel often depends on the information represented on the display unit, it is necessary that faults in the display, i.e. an incorrectly represented system status, can be detected promptly and reliably.

One way of achieving this is the provision of redundant information in the image data to be displayed. This can, as an example, be done in the case of a display unit employed in a railway signal box by representing a railway track on the one hand through the display of a green section of track and on the other hand through an adjacent image of a signal, also represented in green. Only if both items of information are present in the image shown on the display unit can the user assume that the representation of the image on display unit is correct.

The procedure described however has the disadvantage that at least the safety-critical information, in the form of corresponding image data to be displayed, must be generated redundantly. In addition, it is not entirely possible to exclude the possibility that a faulty representation may, depending on the situation at the time, not be detected by the operator, or only after some delay. It must also be borne in mind that display units in the form, for instance, of the liquid crystal displays (LCDs) that are usual nowadays have a relatively complex structure, and can comprise, for example, their own memory and their own computing unit. As a result of this there is, for instance, a risk that under some circumstances the display may show an old image from the memory, and this may be consistent in itself without in fact representing the actual status of the monitored system.

The present invention is based on the task of disclosing a method that permits particularly reliable and also prompt detection of an incorrect representation of image data on a display unit.

This task is fulfilled according to the invention by a method for detecting an incorrect representation of image data on a display unit, wherein test data is acquired through electronic acquisition of at least one part of the image represented on the display unit and through an electronic evaluation of at least one part of the acquired test data an incorrect representation of the image data on the display unit is detected.

In the context of the description of the present invention, the term display unit refers to those components that perform the actual reproduction of the image data, i.e. the two-dimensional component on which a person can read or observe the image represented using, or on the basis of, the image data. The display unit can receive the image data that is to be displayed from, for instance, a graphics card, a graphics controller or from some other control unit. The components from which the display unit receives the image data that is to be displayed may here be combined with the display unit to form a common component, or may be a separate component, only connected to the display unit through communication equipment.

The image data is the information that represents the input signal to the display unit or the basis for the representation of the image. Preferably the image data here is a quantity of individual, preferably digital, data values, each of which provides image values for individual pixels, i.e. points on the image that is to be displayed.

According to the method according to the invention, test data is initially acquired through electronic acquisition of at least one part of the image represented on the display unit. This means that the image that is displayed on the display unit on the basis of the image data is automatically detected or read back. On the one hand the entire image represented on the display unit can be detected hereby. On the other hand it is also feasible for merely a part, or multiple parts of the image represented on the display unit to be detected or read back. This is particularly expedient when an examination of the representation of the image data on the display units is only required for selected parts or regions of the image represented on the display unit.

An incorrect representation of the image data on the display unit is then detected through electronic evaluation of at least one part of the acquired test data. This means that the electronically acquired test data is subjected to an electronic, i.e. in particular to an automated evaluation, and that an incorrect representation of the image data on the display unit is detected on the basis of the evaluation carried out.

The method according to the invention offers the particular advantage that it permits the representation of the image data on the display unit to be checked automatically, independently of operating or supervisory personnel.

Advantageously the entire path from the transmission of the image data to be displayed on the display unit through to the actual representation on the display unit can hereby be checked, so that faults occurring at any location along this path can be reliably detected, and that, due to the electronic acquisition and evaluation, this detection is also prompt.

Preferably the method according to the invention can be further developed in such a way that the test data is acquired by means of an electronic camera aimed at the display unit. This has the advantage that the acquisition of the test data by means of an electronic camera aimed at the display unit is a particularly simple method that can be comparatively economically implemented for acquiring the test data. Preferably here the camera can be fastened to the display unit itself.

According to a further particularly preferred embodiment of the method according to the invention, the test data is acquired by means of photo-sensors arranged on the display unit. This means that the photo-sensors are arranged on the display unit itself, as a result of which direct, undistorted acquisition of the test data is enabled. A precondition for this is that the photo-sensors are arranged on the display unit in such a way that the image that is represented on the display unit continues to be recognizable.

Preferably the method according to the invention can here be further developed in such a way that the test data is acquired by means of a translucent photo-sensitive membrane attached to the display unit. This is advantageous, since by means of an appropriate sensor membrane, it is possible to acquire the test data for any display units, without the necessity of modifying the display unit itself for this purpose. The photo-sensors in the photo-sensitive membrane could here advantageously be independent of the size and number of the pixels, i.e. the resolution, of the monitor.

Because of the fact that a suitable translucent photo-sensitive membrane can be applied directly to the display unit, it is advantageously not necessary to provide focusing.

According to a further particularly preferred embodiment, the method according to the invention is developed in such a way that the test data is acquired by means of photo-sensors integrated into the display unit, implemented so as to detect the light from at least one pixel of the display unit that is physically adjacent to the photo-sensor concerned. This means that, according to this embodiment, the photo-sensors are arranged in intermediate spaces between the pixels of the display unit. Preferably here the photo-sensors are constructed in such a way that they are shaded towards the outside, i.e. to the front of the display unit, and to a large extent only acquire the light from the at least one pixel physically adjacent to the photo-sensor concerned. As a result, the method is made insensitive to stray light. The image can be acquired or recorded by acquiring the test data using a resolution that matches that of the display unit or with a lower resolution. Using a display unit with integrated photo-sensors for acquiring the test data, i.e. to read back the represented image, offers the advantage that the display unit can maintain a comparatively flat structure, and moreover in particular that any impairment of the quality of the representation of the image data on the display unit by the recording equipment, i.e. the photo-sensors, is avoided. Optical focusing here is advantageously again not required in this case.

It should be noted that it is also possible to employ more than one of the possibilities for acquiring the test data mentioned above at the same time. It is thus, for instance, feasible for the test data to be acquired on the one hand by means of an electronic camera aimed at the display unit and on the other hand, for acquisition of the test data by means of photo-sensors integrated into the display unit to also be carried out at the same time. Depending on the particular application and its associated features, an appropriate redundant acquisition of the test data can in particular increase the quality or the speed of the electronic evaluation.

According to a further particularly preferred embodiment, the method according to the invention is configured in such a way that the electronic evaluation of the at least one part of the acquired test data comprises a comparison between the at least one part of the acquired test data with at least one part of the image data. With the help of suitable hardware and/or software, the acquired test data, or at least a part of that data, can be compared with the corresponding image data. Preferably it should be ensured that the hardware components used for representing the image data and for acquiring the test data are sufficiently independent from one another that the data used for comparison with the image data can only be provided by the electronically acquired test data. Inasmuch as the comparison, which may be carried out in a variety of ways and which can, for instance, comprise processing of the image data and/or of the test data, shows that they are in agreement, the representation of the image data on the display unit is correct; on the other hand, in the case of a difference, it can be assumed that the representation of the image data on the display unit is incorrect. The significance or interpretation of the inconsistency can vary, depending on the type and purpose of the representation of the image data on the display unit.

Preferably the method according to the invention can, in addition or as an alternative, also be implemented in such a way that the electronic evaluation of the at least one part of the acquired test data comprises a comparison between the at least one part of the acquired test data with the reference data associated with the image data concerned. This is advantageous since in this way the comparison of the at least one part of the acquired test data with the corresponding image data is simplified. To the extent that certain image data occurs frequently, it is thus in this way possible to determine and acquire reference data for this image data, which permits a particularly simple, fast comparison of the at least one part of the acquired test data with the reference data. For this purpose, the reference data can differ from the associated image data both in terms of the data format and in terms of its content. The reference data can thus, for instance, comprise “target test data” determined from the corresponding image data.

According to another particularly preferred implementation of the method according to the invention, the electronic evaluation of the at least one part of the acquired test data comprises an interpretation of the content of the test data. This means that in the course of the electronic evaluation of the test data, as an alternative or in addition to a comparison between target and actual values, an interpretation of the content of the image read back, i.e. the test data, is also possible. An appropriate interpretation of the contents of the test data using, for instance, automatic text recognition such as, for instance, OCR (Optical Character Recognition), and/or automatic image recognition, can be performed here. The focus here is thus less on the representation of the image data itself, and more on the information conveyed by means of the representation. This has the advantage that, even without knowledge of the contents of each specific pixel on the target display, i.e. the image data, a suitable image interpretation unit can be used to check the image represented on the display unit in a manner that is appropriate for safety purposes. Advantageously this is also possible in the case of complex, changing representations.

According to another particularly preferred embodiment, the method according to the invention is configured in such a way that the acquisition of the test data and the electronic evaluation of the at least one part of the acquired test data are carried out continuously or at regular intervals. This is advantageous because an incorrect representation of the image data on the display unit can be detected particularly promptly.

According to another preferred embodiment of the method according to the invention, image data to be displayed is transmitted in the form of a test pattern to the display unit. This offers the advantage that the use of test patterns simplifies the electronic evaluation of the at least one part of the acquired test data, since in this case the expected test data is known. In addition, through the use of a test pattern, those functions of the display unit that quite possibly are not being used at the time concerned but which nevertheless may be necessary in situations that will occur in the future, can be tested. This might, for instance, concern the representation of particular colors, or the driving of specific areas of the display unit. Preferably, suitable test patterns can be regularly transmitted and displayed for very short times whereby the duration of the display can preferably be shorter than the perceptive capability of the human eye, so that an observer of the display unit is not, or is only insignificantly, disturbed by the transmission of the test pattern. Through appropriate synchronization of the transmission or representation of the test pattern with the acquisition or the reading back, it is possible for the time for which the test pattern is represented to be reduced to durations of, for instance, less than 0.1 second.

In terms of the equipment, the present invention is based on the task of disclosing equipment that permits particularly reliable and at the same time prompt detection of an incorrect representation of image data on a display unit.

This task is fulfilled according to the invention by equipment for detecting an incorrect representation of image data on a display unit, the equipment comprising the display unit for representing an image, a first means for acquiring test data through the electronic acquisition of at least one part of the image represented on the display unit, and a second means for detecting an incorrect representation of the image data on the display unit employing an electronic evaluation of at least one part of the acquired test data.

The advantages of the equipment according to the invention correspond to a large extent to those of the method according to the invention, so that in this respect reference is made to the corresponding explanations above. The same applies to the preferred further developments of the equipment according to the invention described below, so that in this respect again reference is made to the associated explanations given in connection with the corresponding preferred further development of the method according to the invention.

Preferably the equipment according to the invention is designed in such a way that the first means comprises an electronic camera aimed at the display unit.

According to another particularly preferred further development of the equipment according to the invention, the first means comprises photo-sensors arranged on the display unit.

Preferably the equipment according to the invention can also be configured in such a way that the first means comprises a translucent photo-sensitive membrane attached to the display unit.

According to another particularly preferred implementation, the equipment according to the invention is configured in such a way that the first means comprises photo-sensors integrated into the display unit that are implemented in order to detect the light from at least one pixel of the display unit that is physically adjacent to the photo-sensor concerned.

According to a particularly preferred further development, the equipment according to the invention is designed to execute the method according to the invention, or to execute the method according to one of the preferred further developments of the method according to the invention described above.

The invention is described with the help of exemplary embodiments in more detail below. Here

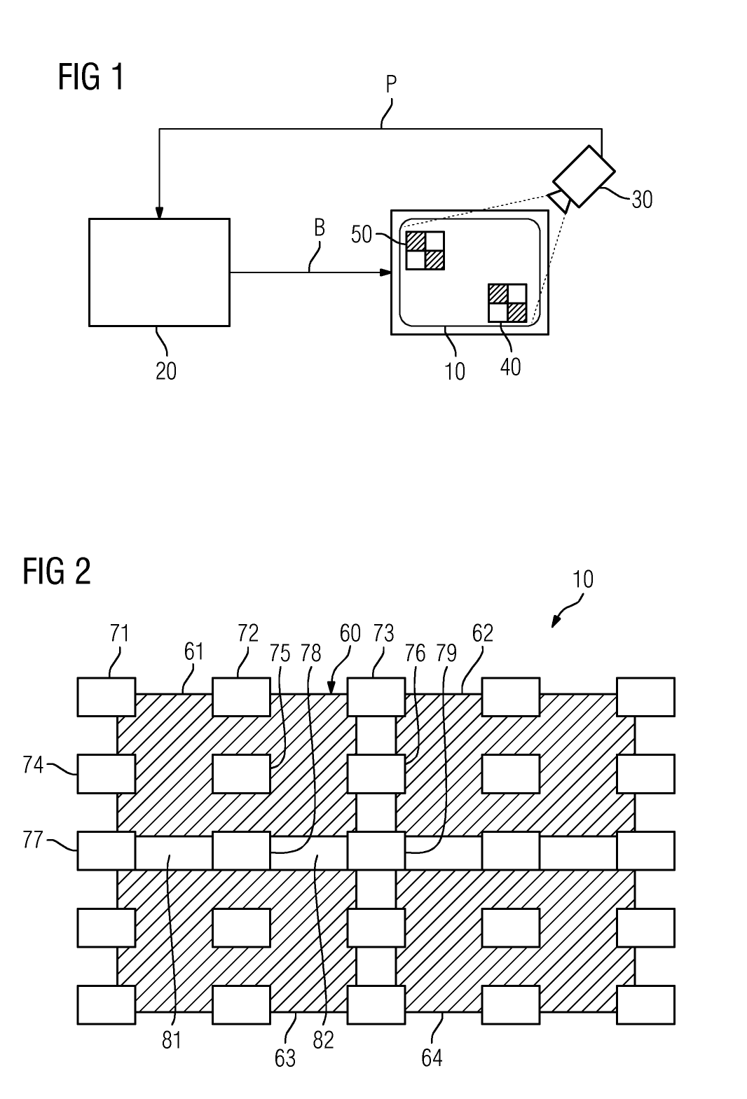

FIG. 1 shows a schematic representation of a first exemplary embodiment of the equipment according to the invention,

FIG. 2 shows a schematic representation of a second exemplary embodiment of the equipment according to the invention,

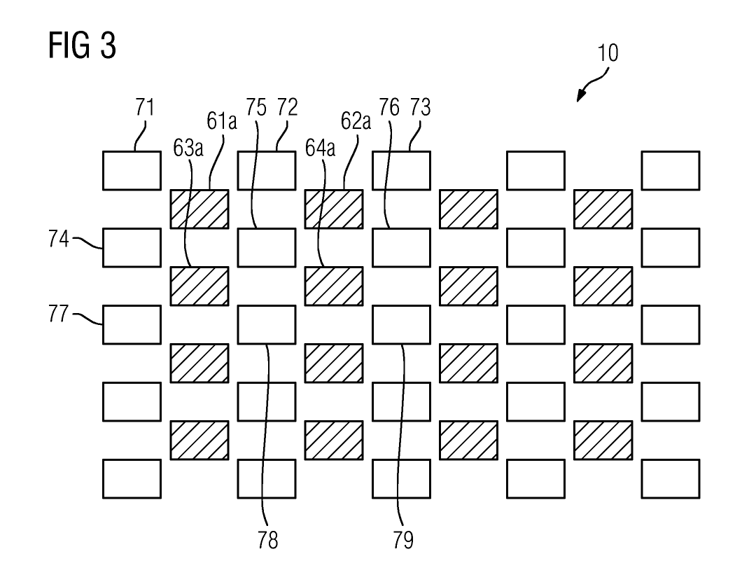

FIG. 3 shows a schematic representation of a third exemplary embodiment of the equipment according to the invention, and

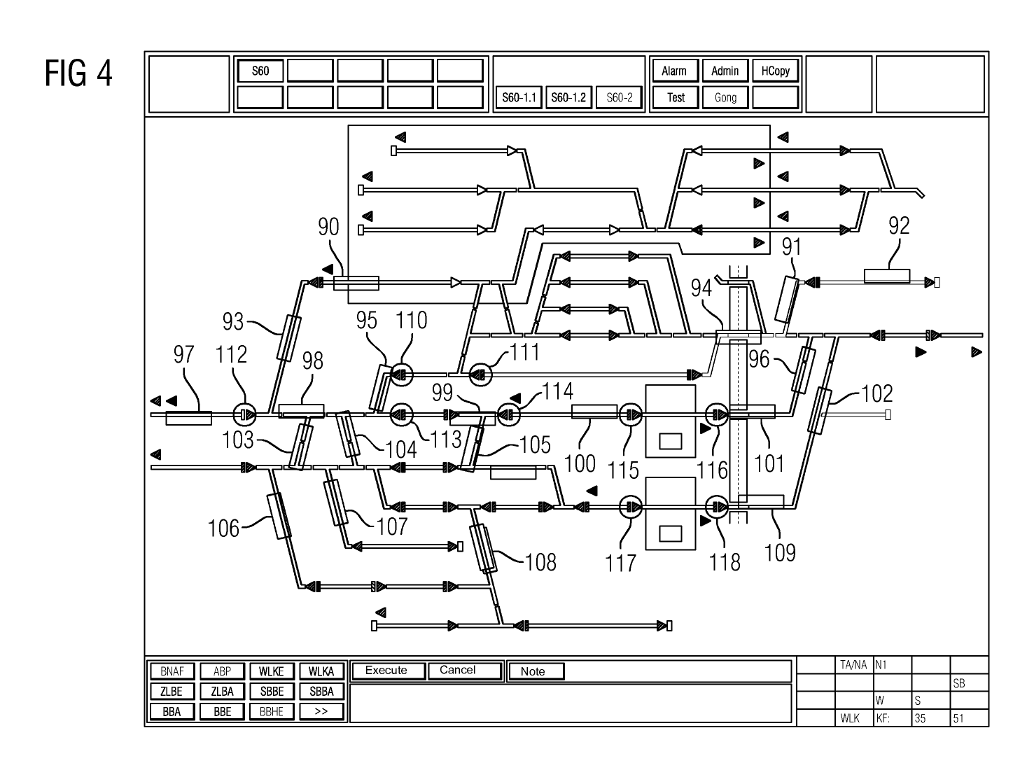

FIG. 4 shows, for the purposes of explaining an exemplary embodiment of the method according to the invention, a schematic representation of an image represented on a display unit.

For reasons of clarity, the same reference numbers have been used in the figures for components that are identical or substantially the same in function.

FIG. 1 shows a schematic representation of a first exemplary embodiment of the equipment according to the invention. It shows a display unit 10, which can comprise a screen, a monitor or a display. A control unit 20 is also provided which can, for example, be implemented as a graphics card, graphics controller or other control computer. Image data B that is to be displayed is transmitted from the control unit 20 to the display unit 10 which represents or reproduces an image on the basis of the received image data B.

In order to be able to detect an incorrect representation of the image data B on the display unit 10, the equipment also comprises a first means of acquiring test data P in the form of a camera 30. As is indicated in FIG. 1, the camera 30 is here aimed at the display unit 10.

In the context of the exemplary embodiment described it is to be assumed that the test data P related to the whole of the image represented on the display unit 10 is acquired by the camera 30. The acquired test data P is transmitted from the camera 30 to the control unit 20, where it is subjected to electronic evaluation. In the context of the exemplary embodiment described it can be assumed here that, in the light of the specific application of the display unit 10 in the present situation, the representation of the image is only relevant or critical to safety in the parts or regions 40, 50. For this reason the electronic evaluation of the acquired test data P is only carried out on the test data P acquired for the parts 40, 50 of the image. Alternatively, or in addition to this, it would in principle of course also be feasible for the test data in the first place only to be acquired for a part of the image. This could, for instance, be done by having the camera 30 only aimed at a part of the display unit 10 or of the image displayed on it.

The equipment shown in FIG. 1, and the method described in this context, offer the particular advantage that the two-dimensional image represented on the display unit 10 is acquired by means of the test data P in very much the same form as it is seen by an operator. This means in particular that incorrect representations that arise on the path to the display unit 10, or within the display unit 10 itself, can be detected. Advantageously the testing is performed here independently of an operator of the display unit 10, whereby the complete path from the output of the image data B to be displayed, i.e. from the transmission of the image data B from the control unit 20 to the display unit 10, right up to the actual display on the display unit 10, is included in the test.

The testing can preferably be carried out continuously or cyclically, i.e. regularly repeated. Here the monitoring of the representation of the image data in the context of the method is advantageously executed on the contents of the target image; in other words it is not restricted to checking whether the display unit 10 is in principle capable of representing image data.

In addition, or in some cases also as an alternative to this, it is possible to perform a comprehensive test of the functions for representing the image data on the display unit 10 by inserting test patterns for what can be only a very short duration. This has the advantage that sources of error, in particular including those within the display unit 10 itself, can be detected or made visible promptly.

The exemplary embodiment of the equipment according to the invention represented in FIG. 1 has a certain disadvantage, in that the field of view including the display unit 10 in front of the camera 30 must remain free at all times if the method is to work correctly and reliably. For this purpose it is desirable for the angle of view of the camera 30 to be as shallow as possible with respect to the display unit 10. This, however, can result in a geometrically distorted image, and it may in some circumstances therefore be necessary to apply subsequent image processing to rectify the copy of the image represented on the display unit 10 acquired in the form of the test data. In such a case, the camera 30 should preferably possess a resolution such that an interpretation of the image can still be made after its shape has been restored.

In addition to the possibility of distortions, it is possible with the exemplary embodiment of FIG. 1, depending on the particular conditions, also under some circumstances for reflections on the display unit 10 to create difficulties for the image detection, i.e. the acquisition of the test data P by the camera 30 and the subsequent electronic evaluation of the test data P.

FIG. 2 shows a schematic representation of a second exemplary embodiment of the equipment according to the invention. Unlike FIG. 1, only a part or section of a display unit 10 is shown here.

In the exemplary embodiment of FIG. 2, the acquisition of the test data is carried out by a first means that comprises photo-sensors arranged on the display unit 10. In this case it would, for example, be feasible for the photo-sensors to be arranged on or in a sheet of glass arranged in front of the display unit 10. In the context of the exemplary embodiment of FIG. 2, however, it can be assumed that the first means comprises a translucent photo-sensitive membrane 60 applied to the display unit 10. The translucent membrane 60 comprises photo-sensors 61, 62, 63 and 64 arranged in such a way that, for instance, the photo-sensor 61 is adjacent to or surrounded by pixels or image points 71 to 79 of the display unit 10.

The photo-sensitive membrane or layer 60 covers a part of the image represented on the display unit 10, so that as a rule the content of the image is darkened. The photocells of the photo-sensitive membrane 60 face towards the display unit 10, and are therefore significantly less sensitive to light scattered from the environment than to the light of the display unit 10, i.e. to light transmitted by the pixels.

In the exemplary embodiment of FIG. 2, the photo-sensors 61 to 64 each acquire a group of pixels or image points on the display unit 10, so that the acquisition of the test data by the photo-sensors 61 to 64 is performed at lower precision or resolution than the actual image output on the display unit 10. In order to ensure sufficiently reliable evaluation of incorrect representations of graphic elements on the display unit 10, the resolution of the recorded image, i.e. the acquired test data, must if at all possible be at least sufficient for the evaluation of image contents with the size of about 10 mm² (i.e. information presented as a “dot” with color information). In this case, text recognition using, for instance, OCR, is still possible, at least in the case of text displayed at a sufficiently large size.

In order to avoid an influence on the photo-sensors by pixels of the display unit located further away, screens can advantageously be provided. This is indicated in FIG. 2 by the screens 81, 82, that are provided in the intermediate spaces between the photo-sensors 61 and 63, between pixels 77 and 78 and between 78 and 79.

The reduced resolution used to acquire the test data, i.e. the smaller number of photo-sensors as compared with the number of pixels, advantageously ensures that the image represented on the display unit 10 continues to be recognizable for the operating or monitoring personnel who are using the display unit 10. Advantageously, the two-dimensional application of the translucent membrane 60 avoids distortion in the course of the image acquisition, as a result of which no focusing is needed in order to acquire the test data.

Preferably the arrangement can be calibrated for the particular screen position and image geometry on the basis of software. It is possible here, for example, for significant representations to be detected during a learning phase, and the positions of the representations concerned to be stored.

FIG. 3 shows a schematic representation of a third exemplary embodiment of the equipment according to the invention. The representation shown in FIG. 3 here corresponds largely to that of FIG. 2, whereby, as a fundamental difference from the exemplary embodiment of FIG. 2, the first means comprises photo-sensors integrated into the display unit 10, designed to detect the light from at least one pixel, physically adjacent to the photo-sensor concerned, of the display unit 10. Specifically, FIG. 3 identifies, by way of example, photo-sensors 61a to 64a, arranged in the intermediate spaces of the pixels or image points 71 to 79, and integrated into the display unit 10 itself. This has the advantage that darkening of the image represented is reduced or fully eliminated.

In the context of the exemplary embodiment of FIG. 3, the representation of the image data and the acquisition or reading back of the image represented in the form of the test data is advantageously carried out by two electronic processing units that are independent from one another. This ensures that errors in the representation of the image do not also affect the image acquisition, as would conceivably for example be the case in which the same processing unit is used for image output and image acquisition. Preferably the image acquisition—with the exception of the integrated photo-sensors—is realized in this way independently of the image output.

The photo-sensors 61a to 64a are constructed in such a way that they are shaded to the outside, and only receive the light from the pixels that surround them. As far as the rest of their structure is concerned, the display unit 10 according to the exemplary embodiment of FIG. 3 can be constructed similarly to the display known from the published application US 2006/0007222 A1. The known display nevertheless has the fundamental difference that the photo-sensors face towards the front of the display unit, in order to acquire, as a camera, the image of, for instance, an observer of the display unit concerned.

In the context of the exemplary embodiment of FIG. 3, the acquisition of the test data can be carried out with a resolution similar to that of the resolution of the display unit, or it may be done with a lower resolution.

In general, the display unit according to the exemplary embodiment of FIG. 3 has the advantage that the overall structure is flat, and the quality of the representation is not impaired by the technical components required in order to acquire the test data. At the same time, advantageously, neither focusing nor complex geometrical calibration is required, since this is already fixed by the way in which the display unit itself is constructed.

FIG. 4 shows a schematic representation of an image represented on the display unit for the purposes of explaining an exemplary embodiment of the method according to the invention. Specifically, here, an example of a representation of image data on an operating and control display in a signal box in an automated railway system is shown. Various sections of track and points can be seen, as are indications of signals.

Regardless of which kind of acquisition of test data described in connection with the exemplary embodiments of FIGS. 1 to 3 is used, electronic evaluation of at least part of the acquired test data is necessary in order to be able to detect an incorrect representation of the image data on the display unit. Preferably here a comparison of the at least one part of the acquired test data with at least a part of the image data is carried out. Alternatively, or in addition, it is also possible to interpret the contents of the image read back by means of the acquired test data.

Fundamentally it is expedient for the acquisition of the test data and the electronic evaluation of the at least one part of the test data to be carried out continuously or at regular intervals. The specification of the testing interval and of the areas of the display unit or of the represented image that are to be checked is carried out in relation to the particular application and to the fundamental risk considerations applicable to the case. The check interval will here generally be based on the danger that arises as a result of a possible incorrect representation. It is, for instance, feasible for the aim to be to avoid an incorrect representation of image data remaining for a period of more than 1 second. In that case a standard check interval of 1 second could be used as a basis or specified for the acquisition of the test data and the subsequent electronic evaluation.

As has already been explained, it is also possible for the region of the image section that is to be checked to be specified or determined depending on the particular application, so that the image data represented on the display unit can comprise a mixture of information that is to be checked with information that does not have to be checked. In this way, an unwarranted reaction of the system in a case in which a fault is detected in regions of the display or of the image data represented that are uncritical for safety, is avoided.

Through the acquisition or reading back of the test data it is advantageously possible to interpret the meaning of the represented content. On the one hand this can comprise text recognition, similar to an OCR system, or a general image recognition process. This has the advantage that even without knowing the specific pixel-by-pixel image content of the target display, i.e. of the image data to be represented, a meaningful examination, from the point of view of safety, of the information represented is possible. An example of this would be a tachometer that displays a speed on a display unit in graphic form. In this case, reading back the displayed speed by applying image evaluation to the acquired test data would be appropriate, whereby only the question of whether the speed to be displayed is shown to the observer on the display unit in a recognizable form is checked.

Through the use of reference data or target image patterns assigned to the image data concerned, the electronic evaluation of the test data is possible with relatively little computing. In this case, the expensive correlation comparison of the meaning of the image is advantageously not required, since the comparison image appropriate for the particular method of acquisition of the test data is already available.

Through the use of test patterns, the display unit can be checked for its capability for image representation particularly comprehensively, quickly and reliably. In this case test patterns or test image samples can be shown on the display unit for long enough to permit the corresponding test data to be acquired. This kind of use of test patterns or test images is expedient, since an image currently on display does not necessarily exploit all the possibilities of the display. In other words, for instance, with the system in a normal condition, it may be the case that a represented image does not include the color red. If therefore, the capacity to display the color red remains unused for a long time and if, because of a fault, the corresponding display capabilities are not working reliably, a regular check is expedient so that, if necessary, the display of a red warning is possible, and that it is not only when dangerous circumstances have arisen that the fact that a fault is preventing its display is detected.

In the context of the exemplary embodiment of FIG. 4, it is to be assumed that the image displayed in terms of the tracks represented remains static, and that information that is important to a user is exclusively signaled by changing colors of image elements that remain represented in fixed positions. The current status of the track installation can be understood from colored illumination of tracks and signals. This makes it possible to define individual regions on the displayed image for which an examination of the image data represented is valuable or necessary. This is indicated in FIG. 4 by indicating exemplary parts of the image 90 to 118 represented on the display unit, for which checking of the representation is implemented. On the one hand this concerns test areas for tracks 90 to 109 and on the other hand test areas for signals 110 to 118.

In the context of a method for detecting an incorrect representation of image data on a display unit, it is now possible to acquire test data only for the parts of the image 90 to 118, or if the test data is acquired for the whole of the represented image, only to carry out electronic evaluation of the acquired test data for the parts of the image 90 to 118 concerned. In this connection it should be stressed again that the parts or regions of the image that are to be checked, i.e. the test areas 90 to 109 for tracks, or 110 to 118 for signals, are only sketched in FIG. 4 by way of example, so that in practice other and/or additional test areas can be defined.

The image data, as illustrated in FIG. 4, that is transmitted from a control unit, having a form similar to a control computer, to the display unit are known to the control unit as a number of individual, identifiable elements having attributes such as their color. Since, when the display changes, these elements do not change their position but only their attributes, an electronic evaluation of the test data related to the respective color of the representation is adequate in the context of the exemplary embodiment described here.

In accordance with the explanations of this given above, it is also possible to carry out a check of the representational capability of the display unit by means of briefly output test patterns, which can also be referred to as complete test images, at regular intervals.

It can also be seen from FIG. 4 that through the evaluation of textual content, perhaps in the lower region of the screen, for instance an examination of the representation of the currently approved command, can be performed if this is expedient for safety purposes.

In addition to application in the field of railway signaling or of railway safety engineering, i.e. for instance in connection with control panel displays in signal boxes or displays in train drivers' cabins, the method described above is generally capable of application in any other safety fields where the reliable, prompt and autonomous detection of an incorrect representation of image data on a display unit, independently of human intervention, is significant.

1-16. (canceled)

17. A method for detecting an incorrect representation of image data on a display unit, the method which comprises:
displaying image data on a display unit;
acquiring test data through electronic acquisition of at least one portion of an image represented on the display unit; and
electronically evaluating at least one part of the acquired test data for detecting an incorrect representation of the image data on the display unit.

18. The method according to claim 17, wherein the acquiring step comprises acquiring the test data by way of an electronic camera aimed at the display unit.

19. The method according to claim 17, wherein the acquiring step comprises acquiring the test data by way of photo-sensors disposed on the display unit.

20. The method according to claim 19, wherein the acquiring step comprises acquiring the test data by way of a translucent photo-sensitive membrane attached to the display unit.

21. The method according to claim 17, wherein the acquiring step comprises acquiring the test data by way of photo-sensors integrated into the display unit, configured to detect light from at least one pixel of the display unit that is physically adjacent to a respective photo-sensor concerned.

22. The method according to claim 17, wherein the evaluating step comprises comparing the at least one part of the acquired test data with at least one portion of the image data.

23. The method according to claim 17, wherein the evaluating step comprises comparing the at least one part of the acquired test data with the reference data associated with the image data concerned.

24. The method according to claim 17, wherein the evaluating step comprises interpreting a content of the at least one part of the acquired test data.

25. The method according to claim 17, which comprises carrying out the acquisition of the test data and the electronic evaluation of the at least one part of the acquired test data continuously.

26. The method according to claim 17, which comprises carrying out the acquisition of the test data and the electronic evaluation of the at least one part of the acquired test data at regular intervals.

27. The method according to claim 17, which comprises transmitting the image data to be displayed in the form of a test pattern to the display unit.

28. An assembly for detecting an incorrect representation of image data on a display unit, the device comprising
the display unit for representing an image;
first acquisition means for acquiring test data by electronically acquiring at least one portion of the image represented on said display unit; and
second detection means for detecting an incorrect representation of the image data on said display unit by electronically evaluating at least one part of the test data acquired by said first means.

29. The assembly according to claim 28, wherein said first means comprises an electronic camera aimed at said display unit.

30. The assembly according to claim 28, wherein said first means comprises photo-sensors disposed on said display unit.

31. The assembly according to claim 30, wherein said first means comprises a translucent photo-sensitive membrane mounted to said display unit.

32. The assembly according to claim 28, wherein said first means comprises photo-sensors integrated into said display unit and configured to detect light from at least one pixel of said display unit that is physically adjacent to a respective said photo-sensor concerned.

33. The assembly according to claim 28, configured to execute the method according to claim 17.
